(19) United States
(12) Patent Application Publication
(10) Pub. No.: US 2015/0260155 A1
(43) Pub. Date: Sep. 17, 2015

(54) WIND TURBINE GENERATOR

(71) Applicant: Phillip Ridings, Searcy, AR (US)

(72) Inventor: Phillip Ridings, Searcy, AR (US)

(21) Appl. No.: 14/529,805

(22) Filed: Oct. 31, 2014

Related U.S. Application Data
(60) Provisional application No. 61/951,839, filed on Mar. 12, 2014.

(51) Int. Cl. F03D 1/04; F03D 1/06; F03D 9/00

(52) U.S. Cl. CPC F03D 1/04; F03D 9/002; F03D 1/0625

(57) ABSTRACT

In one exemplary embodiment, a wind turbine generator may be shown and described. The wind turbine generator can include a nacelle defined along a central axis of a wind turbine along a direction of an airstream and housing a generator; a tail blade connected to a tail end of the nacelle, wherein the tail blade spins against the airstream; at least a first body ring airfoil circularly encompassing the nacelle; at least a second body ring airfoil circularly encompassing the first body ring airfoil; at least a third body ring airfoil circularly encompassing the second body ring airfoil; at least a first body ring propeller housed within the at least first body ring airfoil; at least a second body ring propeller housed within the at least second body ring airfoil; and at least a third body ring propeller housed within the at least third body ring airfoil.

### PRIORITY CLAIM

This application claims priority to U.S. Provisional Patent Application Ser. No. 61/951,839, entitled “Wind Turbine Generator”, and filed Mar. 12, 2014, the contents of which are hereby incorporated by reference in their entirety.

### BACKGROUND

The use of wind to generate energy has been known and utilized for many centuries. Windmills have been used to generate energy and to grind grain or pump water from open streams since early history. Such windmills were popularized by the Dutch in the late 1300s in the form of a three blade windmill system to help pump water.

As modern windmills begin to shift away from generating mechanical energy towards electrical energy, further improvements were made to develop windmills into wind turbines. Wind turbines have developed significantly from the fan-type blades and the sail-type blades, and are gradually moving towards vertical-axis rotors. However, despite the significant development in terms of the blades, most wind turbines have made no advances with respect to the overall shape and design of the wind turbines as they still adhere to the traditional three bladed system and structure.

The three blade wind turbine systems have certain limitations that can prohibit them from fully utilizing the full potentials of the naturally available wind in the air. More specifically, the three blade wind turbine systems can be limited by metal fatigue, rotor efficiency, and various other limitations that can prohibit them from taking advantage of the full kinetic energy available in naturally occurring winds.

Fundamentally, Bernoulli's equation governs the streamline airflow of an airfoil and it can be simplified in the form of the equation shown below as equation 1:

P+q=P₀ (Equation 1)

In equation 1, P is static pressure, P₀ is the total pressure and q is the dynamic pressure. Bernoulli's equation denotes that the increase in the speed of the fluid occurs simultaneously with a decrease in pressure or a decrease in the fluid's gravitational potential energy. In an airfoil application, when an airfoil is angled, it increases the pressure gradient between the top and the bottom of an airfoil, thus increasing the velocity of the airflow.

Further, traditional wind turbines are typically inefficient and ineffective in generating electrical energy, as they often cannot take advantage of all of the kinetic energy stored in the naturally occurring wind. As Betz's law indicates, the amount of power generated by a wind turbine is directly proportional to the area swept out by the rotor, to the density of the air, and the cube of the wind speed. This is shown as follows in equation 2:

P=½αρπr²v³ (Equation 2)

Here, P is the power generated, α is the efficiency factor, ρ is the mass density of air, r is the radius of the wind turbine, and v is the velocity of the air. It may therefore be desirable to address the limitations of Betz's law.

### SUMMARY

In one exemplary embodiment, a wind turbine generator may be shown and described. The wind turbine generator can include a nacelle defined along a central axis of a wind turbine along a direction of an airstream and housing a generator; a tail blade connected to a tail end of the nacelle, wherein the tail blade spins against the airstream; at least a first body ring airfoil circularly encompassing the nacelle; at least a second body ring airfoil circularly encompassing the first body ring airfoil; at least a third body ring airfoil circularly encompassing the second body ring airfoil; at least a first body ring propeller housed within the at least first body ring airfoil; at least a second body ring propeller housed within the at least second body ring airfoil; and at least a third body ring propeller housed within the at least third body ring airfoil.

In another exemplary embodiment, a method of generating electricity with a wind turbine may be provided. The method of generating electricity with a wind turbine can include directing an airstream over a nacelle; directing the airstream through at least a third body ring airfoil to rotate at least a third body ring propeller; directing the airstream from the at least third body ring airfoil to at least a second body ring airfoil to rotate at least a second body ring propeller; directing the airstream from the at least second body ring airfoil to at least a first body ring airfoil to rotate at least a first body ring propeller; and generating electricity with a generator based on the rotation of the first body ring propeller, second body ring propeller and third body ring propeller.

In still a further exemplary embodiment, a wind turbine generator may be shown and described. In this exemplary embodiment, the wind turbine generator may include means for directing an airstream into a housing; means for directing the airstream through a plurality of airfoils and a corresponding plurality of propellers; and means for generating electricity.

### BRIEF DESCRIPTION OF THE FIGURES

Advantages of embodiments of the present invention will be apparent from the following detailed description of the exemplary embodiments. The following detailed description should be considered in conjunction with the accompanying figures.

FIG. 1 is an exemplary diagram showing a cutaway view of a wind turbine.

FIG. 1a is an exemplary exploded view of a wind turbine generator.

FIG. 2 is an exemplary diagram showing a perspective cutaway view with emphasis on a tail blade.

FIG. 3 is an exemplary diagram showing a perspective cutaway view with emphasis on body ring propellers.

FIG. 4 is an exemplary diagram showing a nacelle in an open position.

FIG. 5 is an exemplary diagram showing a wind turbine with a retractable pole system.

FIG. 6 is an exemplary diagram showing another view of a wind turbine with a retractable pole system.

FIG. 7 is an exemplary diagram showing a wind turbine generator with a motor.

FIG. 8 is another exemplary diagram of a wind turbine generator.

FIG. 9 is an exemplary diagram of ribbing associated with a wind turbine generator.

FIG. 9a is an exemplary diagram of a wind turbine generator with ribbing attached thereto.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention,” “embodiments,” or “invention” do not require that all embodiments of the invention include the discussed feature, advantage or mode of operation.

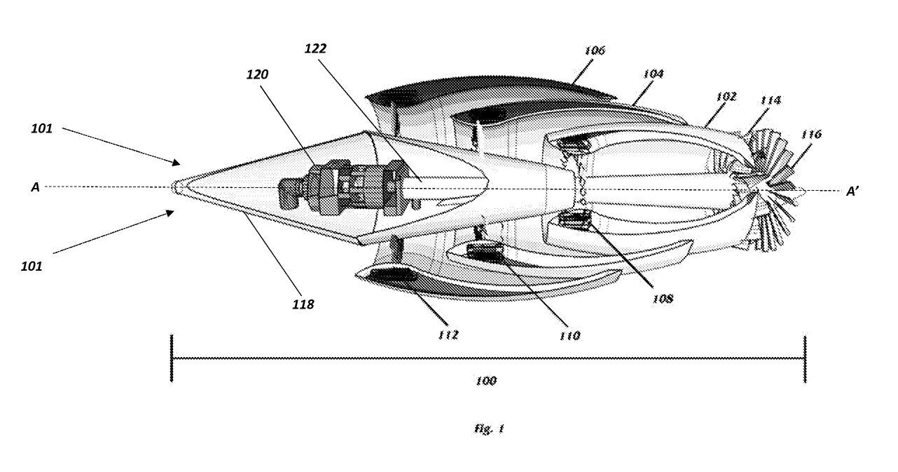

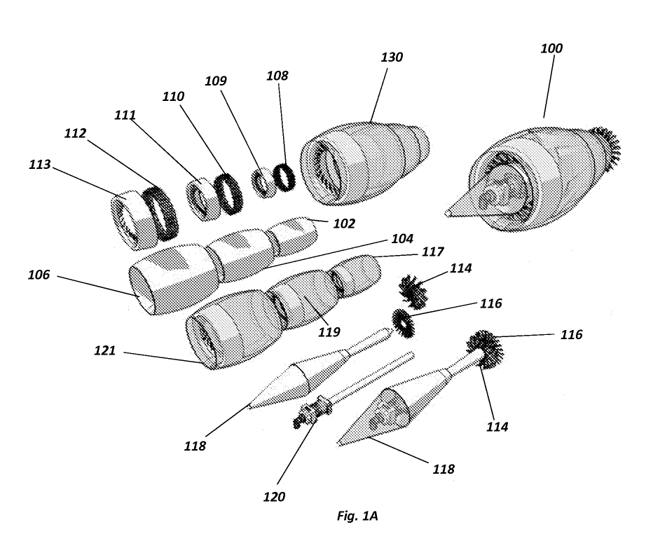

Exemplary embodiments, and generally referring to exemplary FIGS. 1-3, described herein can relate to the field of wind turbines and wind turbine generators. More specifically, exemplary embodiments described herein can describe an apparatus, method and system for more effectively and efficiently converting wind energy into electrical energy. Such examples can maximize airflow through a wind turbine generator by decreasing pressure along a direction of the wind flow, thus increasing wind speed. Such exemplary embodiments may increase the efficiency and effectiveness of a wind turbine in such a fashion that overcomes traditional drawbacks associated with metal fatigue and rotor efficiency.

Turning now to exemplary FIG. 1 and exemplary FIG. 1a, a perspective cutaway view and an exploded view of a wind turbine generator may be shown. Wind turbine generator 100 can have a variety of components, including a first body ring airfoil 102, a second body ring airfoil 104, and a third body ring airfoil 106. Each body ring airfoil 102, 104, and 106 may have a body ring propeller disposed therein. For example, first body ring airfoil 102 may have first body ring propeller 108 disposed therein, second body ring airfoil 104 may have second body ring propeller 110 disposed therein, and third body ring airfoil may have third body ring propeller 112 disposed therein. Additionally, and as shown in exemplary FIG. 1a, each body ring propeller may have a housing associated with it. For example, first body ring propeller 108 may have first housing 109, second body ring propeller 110 may have second housing 111, and third body ring propeller 112 may have third housing 113. A combination of the housings and propellers, along with body ring airfoil housings 117, 119, and 121 may be shown as assembled element 130. A nacelle 118 may be placed along a central axis of the body ring airfoils 102, 104, and 106. Nacelle 118 may run along axis A-A′, which itself may be aligned, manually, automatically, or dynamically, with airstream 101. Nacelle 118 may further contain a generator 120. Generator 120 may be any desired form of generator, for example a generator used to generate electricity generated by the rotation of one or more propellers. It further noted that the first body ring propeller 108, second body ring propeller 110, and the third body ring propeller 112 may be mechanically coupled to generator 120 via driveshaft 122. Additionally, there may be a geared connection between each body ring propeller and driveshaft 122 which can rotate driveshaft 122 and also allow for variable input rotation rates depending on the rotational input speed of the propellers. Additionally, tail blades 116 may be mounted proximate to or coupled with first body ring airfoil 102. In some exemplary embodiments, generator 120 may be used to convert energy associated with tail blades 116 into electrical energy. A diffuser 114 may further be installed proximate tail blades 116. Diffuser 114 may function to smooth airflow over a tail section of wind turbine generator 100.

Still referring to exemplary FIG. 1, body ring airfoils 102, 104, and 106 may be formed and shaped as circular airfoils. Additionally, body ring airfoils 102, 104, and 106 may be angled with respect to an airstream 101 in order to increase or decrease a pressure differential between an inside and an outside of the body ring airfoils 102, 104, and 106. Such a pressure differential could accelerate a velocity of the airstream 101 within the body ring airfoils 102, 104, and 106. Such an acceleration of the airstream 101 can thus increase the rotation speed of the body ring propellers 108, 110, and 112, which, in turn, can increase electrical energy generated by wind turbine generator 100. Further, body ring airfoils 102, 104, and 106 may vary in size, for example, to accommodate or allow each of the body ring airfoils 102, 104, and 106 to capture the wake of the preceding body ring airfoil.

In the exemplary embodiment shown in FIG. 1, three body ring airfoils 102, 104, and 106, may be utilized. However, it may be appreciated that various other numbers of body ring airfoils may be utilized, as desired. For example, different embodiments may use just one body ring airfoil, two body ring airfoils, four body ring airfoils, five body ring airfoils, and so forth. It should thus be appreciated that any number of airfoils may be utilized, as desired, depending on an application, size requirements, material requirements or any other criteria known to one having ordinary skill in the art.

As shown in exemplary FIG. 1, and as discussed previously, body ring propellers 108, 110, and 112 may be installed within body ring airfoils 102, 104, and 106, respectively. Body ring propellers 108, 110, and 112 may rotate or spin when they encounter an airstream 101 flow. The spinning or rotation or body ring propellers 108, 110, and 112 may be utilized to generate electrical energy. Body ring propellers 108, 110, and 112 may be formed as neodymium slotless magnetic alternator-based propellers, standard magnetic coil-based propellers, or any other type of propellers that may be capable of generating electrical energy based on airflow, as desired.

Diffuser 114 of exemplary FIG. 1 may be utilized to diffuse vortices that can occur in the wake of an airstream 101 after passing through an airfoil. In keeping airflow smooth over the tail section after the airstream 101 has passed through body ring airfoils 102, 104, and 106, this residual airstream 101 can be used to generate additional electrical energy, for example by passing the airstream 101 through tail blade 116. It may be noted, however, that tail blade 116 can still function as desired to generate additional electrical energy without the presence of diffuser 114. Thus, it may be appreciated that diffuser 114 may be utilized in some exemplary embodiments, as desired.

In exemplary FIG. 1, and in a further embodiment, tail blade 116 may be connected to a generator 120, which itself may be enclosed with nacelle 118. Tail blade 116 may be used to generate additional energy by taking advantage of a residual airstream 101 from the plurality of body ring propellers 108, 110, and 112, as described above. Additionally, in an exemplary embodiment, nacelle 118 can be a housing for any and all power generating components. Nacelle may include generator 120, a gearbox (not pictured), a drive train (not pictured), and any other components used for the generation of power, as desired. Nacelle 118 may further be formed, adjusted, or tailored to be any desired size, for example to regulate or adjust the amount of airflow through wind turbine generator 100. For example, additional components may be added to nacelle 118 in order to provide a smaller opening for a decrease or other regulation of an airflow through wind turbine generator 100. Alternatively, nacelle 118 may be formed with a larger opening or may have removable or adjustable components that may be manipulated to create a larger opening of wind turbine generator 100, as desired. In still further exemplary embodiments, the opening of nacelle 118 may be dynamically adjustable based on conditions, such as wind speed, and may be adjusted automatically or via remote control.

In a further exemplary embodiment of FIG. 1, generator 120 may be used to generate power from tail blade 116 via a drive shaft 122. Generator 120 may be any desired generator, for example a standard wind turbine generator with a rear mounted drive shaft 122. However, it may be appreciated that generator 120 may be any other sort of generator that may be capable of converting rotational mechanical energy into electrical energy, as known in the art.

In some further exemplary embodiments, it may be appreciated that the blades of body ring propellers 108, 110, and 112 (as well as any other body ring propellers) and the blades of tail blade 116 may be formed in any of a variety of manners. In some examples, the blades may formed as substantially flat. In other exemplary embodiments, each blade may have any number of dimples disposed thereon, which can allow for improved airflow or improved airflow dynamics. Further, any blades may also have holes disposed or formed in desired locations on the blades. Any such combination of holes and/or dimples may allow for improved airflow characteristics. Similarly, any internal body components of wind turbine generator 100, such as the body of nacelle 118, body airfoils 102, 104, and 106, or any other element, may have dimples formed thereon to direct or alter airflow in a desired manner.

In still other exemplary embodiments, wind turbine generator 100 may incorporate a variety of further elements to facilitate efficiency, airflow, and functionality. For example, wind turbine generator 100 may have a body structure that enhances airflow by funneling an airstream 101 in a desired manner. Further, vents may be used in an inlet area and ribs may be used in an internal area to funnel airflow and direct an airstream 101 in desired paths and directions through wind turbine generator 100. Further, heat exchangers or heat sinks may be arranged on an internal portion of wind turbine generator 100 or on nacelle 118 that remove heat from an interior portion of wind turbine generator 100, which can maintain the internal area of wind turbine generator 100 at an optimal or desired temperature for energy generation and material stress reduction. Further, it is envisioned that body ring airfoils 102, 104, 106 may provide heat removal or heat sink capabilities. For example, body ring airfoils may pull heat away from generator 120 and driveshaft 122 and dissipate the heat in an outward fashion, thus reducing internal temperatures and increasing operating efficiency and life expectancy of wind turbine generator 100.

In some other alternative exemplary embodiments, in situations where wind turbine generator 100 is operating in very low ambient temperatures, heating elements may be provided with, disposed on, or coupled to any desired component of wind turbine generator 100. For example, one or more heating elements may be associated with nacelle 118 in order to keep it at a desired operating or static temperature or to generally prevent it from freezing or accumulating ice. Thus, in one exemplary embodiment, an inferred heating element may be utilized at a base portion of nacelle 118. Such a heating element may warm the entirety of nacelle 118 and maintain it at a desired operating temperature.

In still further exemplary embodiments, it may be appreciated that generator 120 and driveshaft 122 may be replaceable or upgradeable. For example, if wind turbine generator 100 needs servicing, nacelle 118 may be opened or removed and either or both of generator 120 and driveshaft 122 may be removed, together or separately, as desired. When removed, generator 120 and driveshaft 122 may be inspected, serviced, repaired, or replaced, as desired. For example, if a more efficient generator becomes available or if a lighter weight, but stronger driveshaft can be utilized, such components may be replaced and utilized in wind turbine generator 100. Similarly, it may be appreciated that body ring airfoils 102, 104, 106 and body ring propellers 108, 110, 112 may be similarly removed for inspection, servicing, repair, etc.

As described in more detail below, a wind turbine generator, such as wind turbine generator 100, may be mounted in any fashion, either alone or in conjunction with any other number of wind turbine generators. When mounted, wind turbine generator may be manually, automatically, or dynamically positioned with respect to an airstream, such as airstream 101. In such embodiments, it may be desirable to angle wind turbine generator 100 at a predetermined angle or a dynamically adjusted with respect to airstream 101. For example, to generate a desired level of efficiency, wind turbine generator may be angled at about 20 degrees to about 40 degrees of airstream 101.

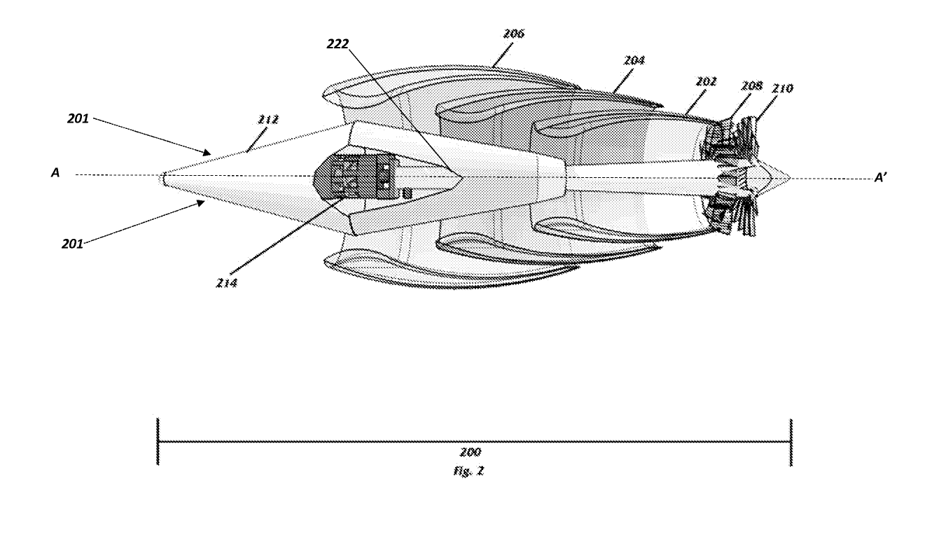

Exemplary FIG. 2 provides an alternative embodiment view of a wind turbine generator. In this exemplary embodiment, wind turbine generator 200 may be formed without one or more body ring propellers. In such an exemplary embodiment, wind turbine generator 200 may utilize body ring airfoils 202, 204, and 206 (or any desired number of body ring airfoils) to increase a velocity of an airstream 201 within wind turbine generator 200. Such an increase in speed of an airstream 201 may allow for a corresponding increase of the rotation speed of tail blade 210.

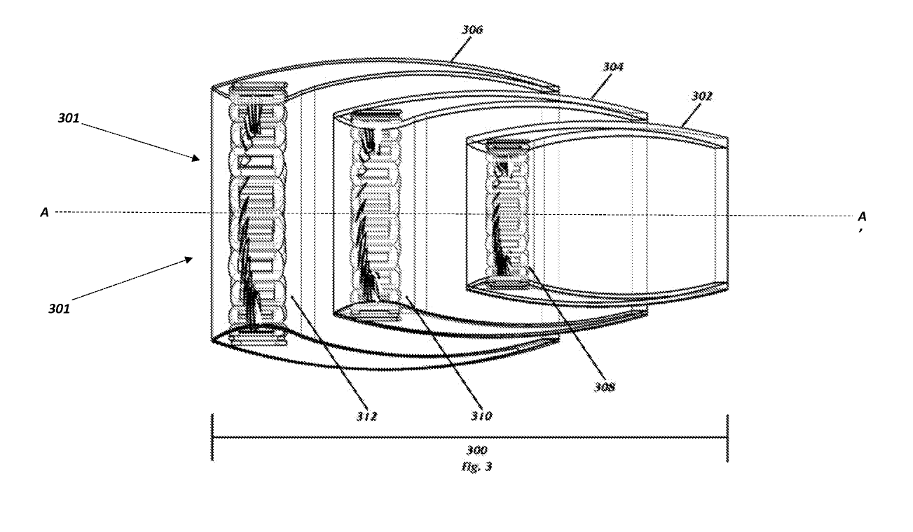

Turning now to exemplary FIG. 3, wind turbine generator 300 may be formed and function without a tail blade. In this exemplary embodiment, wind turbine generator 300 may have body ring propellers 308, 310, and 312 mounted inside corresponding body ring airfoils 302, 304, and 306, respectively. Similar to a previous exemplary embodiment, body ring propellers 308, 310, and 312 may take advantage of an increase in airstream 301 velocity from body ring airfoils 302, 304, and 306 to generate electrical energy.

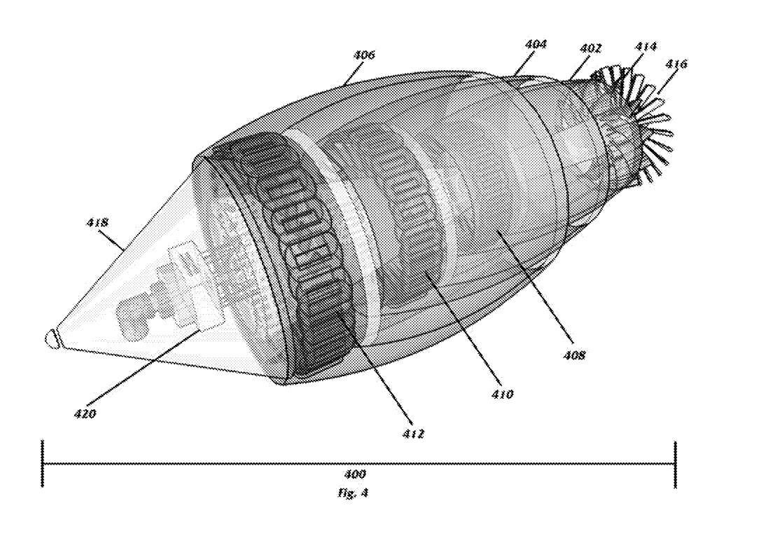

Exemplary FIG. 4 provides a further embodiment where a nacelle is in an open position. In such an open position, a nacelle may act to limit airstream 401 into wind turbine generator 400. Here, nacelle 418 may be formed or may be operationally positioned into an open position, for example a completely opened position. When nacelle 418 is in an opened position, an airstream 401 entrance into wind turbine generator 400 may be closed. In such a position, body ring propellers 408, 410, and 412 may not rotate or spin, and tail blades 416 may also not rotate. Additionally, further actuation can take place to fix or stop body ring propellers 408, 410, and 412, along with tail blades 416, in a stationary or fixed position. Such a positioning of nacelle 418 may be utilized during maintenance or repairs of wind turbine generator 400. Additionally, such positioning of nacelle 418 may be utilized in undesirable weather conditions so as to prevent damage to any internal component of wind turbine generator 400. However, it may be appreciated that nacelle 418 may be positioned or adjusted to control the amount of airstream 401 into wind turbine generator 400. Such adjustments may be made automatically or manually and may allow for an opening of anywhere from 0% to 100%. In some alternative exemplary embodiments, an additional cover or shell may be mounted over nacelle 418. The cover or shell could be hollow and could allow for further adjustment or variation of airflow or the volume of air entering the wind turbine generator 400. Additionally, in some exemplary embodiments, vents may be utilized on or with nacelle 418. Such vents may be utilized wherein, when there is an excess or undesired amount of airflow, the vents may be opened to reduce pressure to maintain the operation of wind turbine generator 400 in a desired fashion.

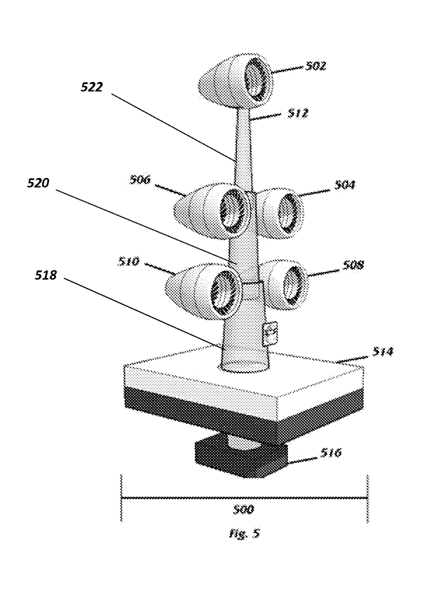

Exemplary FIG. 5 provides another embodiment whereby a retractable pole system may be utilized with one or more wind turbine generators. In this exemplary embodiment, a wind turbine system 500 may be provided. Wind turbine system 500 may include wind turbine generators 502, 504, 506, 508, and 510, although it is envisioned that any number of wind turbine generators may be utilized in such a wind turbine system 500. Support pole 512 may be provided and may rise out of a portion of base 514. Support pole 512 may be located in a substantially central portion of base 514, although the positioning of support pole 512 may be varied depending on desired circumstances. Additionally, support pole 512 and base 514 may be formed integrally out of any known or desired material or materials, or support pole 512 may be formed and coupled or anchored to base 514. In any such embodiments, it may be envisioned that any desired material or combination or materials of materials may be used for support pole 512 and base 514. Further, base 514 can be formed of a structure that houses water or batteries. In the case of water, base 514 may be lightweight to ship and position and may be filled and sealed with water to provide a solid base structure. Alternatively, in the case of utilizing batteries, base 514 may be filled with batteries or fuel cells that can store or retain power generated by any wind turbine generator. Base 514 may be such that it functions as a solid base due to the weight of the batteries or fuel cells. Additionally, base 514 may be sealed so as to protect the batteries or fuel cells from any outside elements, although there may be one or more outputs that provide for the transmission of stored energy or electricity. A single wind turbine generator, such as wind turbine generator 502, may be positioned at a top portion of support pole 512 and may be coupled or anchored thereto in any known or desired fashion. Further, a counter balance or counter weight 516 may be disposed beneath base 514 or on a bottom portion of base 514. It may be appreciated that counter weight 516 may be formed integrally with base 514 or may be formed separately from base 514 and coupled or anchored thereto in any known or desired fashion. Further, counter weight 516 may be formed out of any desired material or materials.

As shown in exemplary FIG. 5, any number of wind turbine generators may be associated with, coupled to, or disposed on support pole 512. Wind turbine generators, such as wind turbine generators, 502, 504, 506, 508, 510, may be coupled to support pole 512 in any desired manner. Additionally, in some further exemplary embodiments, wind turbine generators may be actuated, tilted, rotated, or have any other movement take place that can allow for repositioning of wind turbine generators associated with support pole 512. Such movement may be done in conjunction with or separately from any movement of support pole 512. Additionally, actuation or movement of any wind turbine generators may be done independently from or in conjunction with any other wind turbine generators. Further, actuation or movement of any wind turbine generators may be performed to better position the wind turbine generators, to allow for safe positioning of any wind turbine generators, or for any other reason, as desired. Actuation or movement described herein may be performed by one or more servo motors or any other motor mounted inside support pole 512. Additionally, there may be multiple servo motors or other motors in support pole 512 to actuate any one wind turbine generator so as to provide more efficient movement or redundancy in the event of a single motor failure.

In the exemplary embodiment of FIG. 5, support pole 512 may be fixed or retractable, as desired. In some examples, support pole 512 may be formed out of a number of collars, for examples collars 518, 520, and 522. Collars 518, 520, and 522 may be such that they can be substantially retracted into collar 518 or extended, as shown in exemplary FIG. 5. Additionally, as stated previously, any number of wind turbine generators may be disposed on or coupled to support pole 512. For example, wind turbine generators may be disposed on or coupled to support pole 512 so as to provide proper balance or support for other wind turbine generators. For example, a single wind turbine generator 502 may be placed at a top portion of support pole 512, and/or pairs of wind turbine generators, such as pairs 504 and 506 and 508 and 510, may be disposed on corresponding sides of support pole 512. Such arrangements may provide desired structure and support for support pole 512, although any number of wind turbine generators may be placed in any desired location.

In some further exemplary embodiments, any wind turbine generator or generators mounted in a support pole 512 may be removably mounted. In such exemplary embodiments, support pole 512 may be shipped and positioned with base 514 prior to the attachment of or coupling to any one or more wind turbine generators. This can allow for ease of transport and placement, while also providing for ease of servicing or replacement of any wind turbine generators on support pole 512.

In still a further exemplary embodiment, support pole 512 may be retracted or extended, as desired. As shown in exemplary FIG. 5, support pole 512 may be in an extended position. However, in some circumstances, such as adverse weather conditions, servicing time for one or more wind turbine generators, or replacement of one or more wind turbine generators, it may be desirable to retract support pole 512. Thus, in either a manual or automatic fashion, support pole 512 may be retracted to a lowered or retracted position. Such movement may be accomplished in any desired fashion, for example a motor associated with support pole 512 or through a manual system, such as a crank. Further, in some other exemplary embodiments, the height of support pole 512 may be adjusted to take advantage of a desired airstream. For example, if there is a desired airstream at a higher altitude, support pole 512 may be raised to provide a more desired positioning of wind turbine generators.

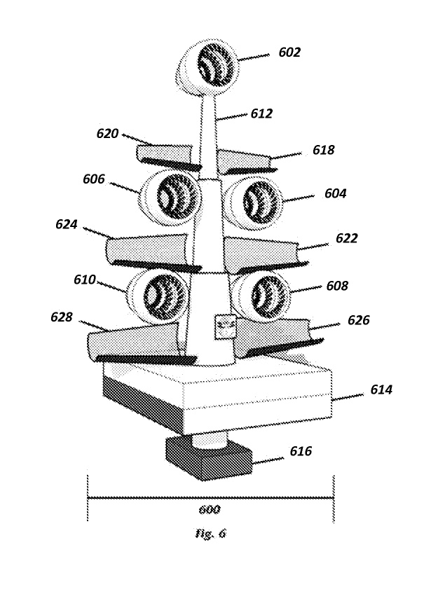

Exemplary FIG. 6 provides a further embodiment where wind turbine generators may be mounted on a retractable pole and solar panels may be utilized to gather further energy. As in a previous embodiment, any number of wind turbine generators (for example generators 602, 604, 606, 608, and 610) may be mounted on or otherwise coupled to support pole 612. As shown in exemplary FIG. 6, any number of solar panels, such as solar panels 618, 620, 622, 624, 626, and 628 may also be mounted on support pole 612. Such solar panels may be used to gather, collect and store solar energy and convert it to electrical energy, in traditional or known solar panel fashion. However, the electrical energy generated by the solar panel or panels may then be utilized to help spin the wind turbine generators, as desired. For example, any number of solar panels may collect and store energy that may be used to supply additional energy to drive any wind turbine generators in certain circumstances. For example, if there is insufficient wind to power the wind turbine generators, solar panels may be used to supplement the existing airstream and increase performance of the wind turbine generators.

As shown in exemplary FIG. 6, solar panels 618, 620, 622, 624, 626, and 628 may be placed in a variety of positions on support pole 612. For example, they may be placed proximate or between wind turbine generators 602, 604, 606, 608, and 610. However, it may be appreciated that, similar to the placement of any number of wind turbine generators, solar panels may be placed in any desired position or positions on support pole 612 and relationally with respect to any wind turbines while still collecting desired solar energy.

In still other exemplary embodiments, various other pole designs and structures may be utilized, as desired. For example, two or more support poles may be mounted together on a base to provide further orientations or arrays of wind turbine generators and/or solar panels. Also, geometric shapes, such as triangles, could be utilized to provide a solid, supported pole structure while also offering a desired array of wind turbine generators in an airstream. In some other exemplary embodiments, triangle poles may be utilized that can provide for a substantially linear array of wind turbine generators. Any such orientation may be supported and laid out as desired.

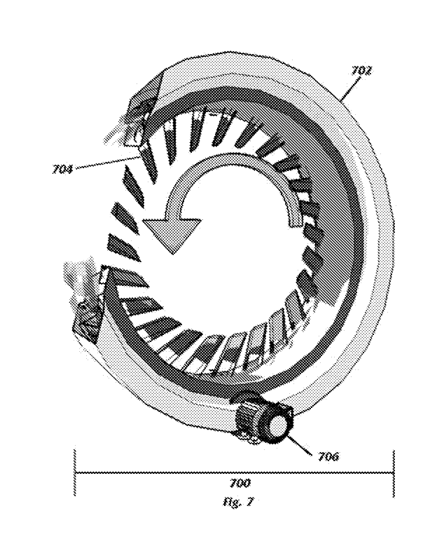

Exemplary FIG. 7 provides a view of a wind turbine generator. In this exemplary embodiment, wind turbine generator 700 may have a body ring airfoil 702, a body ring propeller 704, and a motor 706. Motor 706 may be utilized to spin or rotate body ring propeller 704 using air power from a airstream traveling through wind turbine generator 700, through solar power collected by a solar panel associated with wind turbine generator 700, and/or through electrical energy stored in an electrical storage unit.

Still referring to exemplary FIG. 7, motor 706 may be a standard or known electrical motor and may be powered by any source of electricity, for example electricity from an electrical storage unit or electricity received and generated from one or more solar panels. It may be appreciated, however, that motor 706 may be any other type of motor which may be capable of spinning body ring propeller 704. Additionally, any combination of motor 706 and solar panels, or other electrical providing component, can allow wind turbine generator 700 to generate electrical power based on the solar power or stored power when, for example, there is insufficient or an undesired airstream through wind turbine 700.

In still further exemplary embodiments, and still referring to FIG. 7, electrical energy stored in an electrical storage unit may derive its source of power from solar panels, such as those shown in exemplary FIG. 6, when there is a desired amount or excess amount of energy in such solar panels. Additionally, an electrical storage unit may also derive its source of power from body ring propellers, such as body ring propellers 108, 110, and 112 shown in exemplary FIG. 1, when they produce excess or desired energy. Additionally, an electrical storage unit may also derive its power from a tail blade, such as tail blade 116 of exemplary FIG. 1, or any other component associated with a wind turbine generator and which may be capable of generating electrical energy.

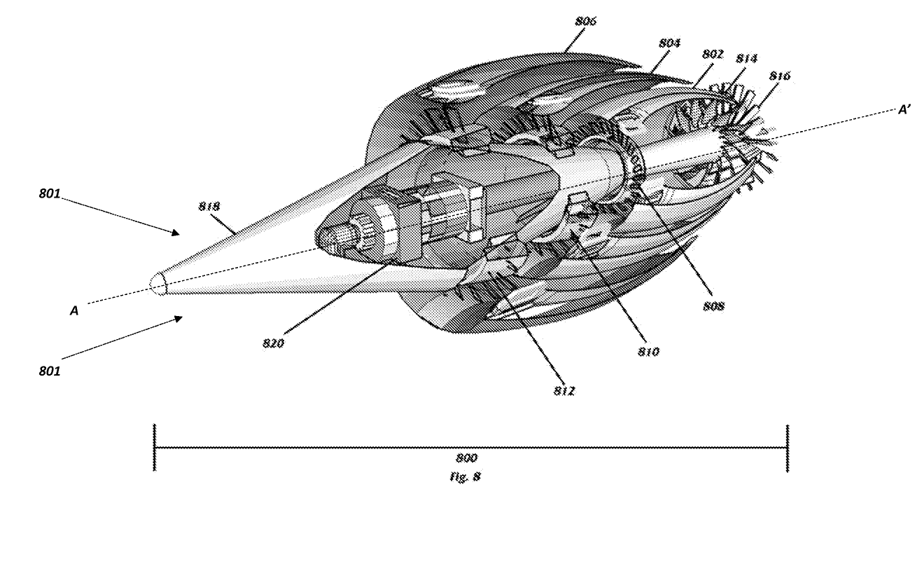

Referring now to exemplary FIG. 8, another exemplary embodiment of a wind turbine generator may be shown. Here wind turbine generator 800 could have a first body ring airfoil 802, a second body ring airfoil 804, and a third body ring airfoil 806. Connected to each of the body ring airfoils 802, 804, and 806 may be one or more body ring propellers, such as body ring propellers 808, 810, and 812. In one exemplary embodiment, body ring propellers 808, 810, and 812 may be positioned outside of body ring airfoils 802, 804, and 806, respectively.

Still referring to exemplary FIG. 8, in this embodiment wind turbine 800 may spin when encountering an airstream flow, which may then generate electrical energy, as in previous embodiments. However, here the body ring airfoils 802, 804, and 806 may be supported by nacelle 818 of wind turbine generator 800 and ribs associated with nacelle 818.

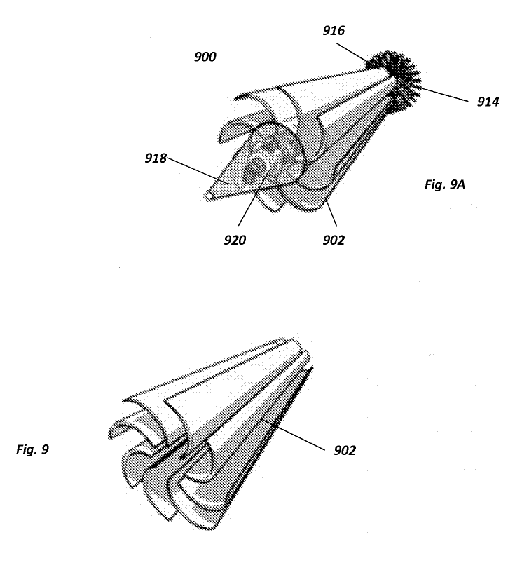

In another exemplary embodiment, and now referring to FIGS. 9 and 9a, ribs may be used to assist in heat dissipation and airstream management. In this exemplary embodiment, ribs 902 may be disposed on or about nacelle 918. The ribs may be formed out of any desired material, for example, to extract and help dissipate heat generated in or around nacelle 918. Additionally, ribs 902 can provide directed movement of heat over the entirety of nacelle 918, for example in a uniform fashion. Additionally, ribs 902 may be shaped or formed such that they direct or funnel an airstream in desired directions. Such directing or funneling of an airstream may provide for improved air flow through any body ring propellers in wind turbine generator 900.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed:

1. A wind turbine generator, comprising:
a nacelle defined along a central axis of a wind turbine along a direction of an airstream and housing a generator;
a tail blade connected to a tail end of the nacelle, wherein the tail blade spins against the airstream;
at least a first body ring airfoil circularly encompassing the nacelle;
at least a second body ring airfoil circularly encompassing the first body ring airfoil;
at least a third body ring airfoil circularly encompassing the second body ring airfoil;
at least a first body ring propeller housed within the at least first body ring airfoil;
at least a second body ring propeller housed within the at least second body ring airfoil; and
at least a third body ring propeller housed within the at least third body ring airfoil.

2. The wind turbine generator of claim 1, further comprising:
a tail blade connected to a tail end of the nacelle.

3. The wind turbine generator of claim 1, the wind turbine generator receives an airstream along the nacelle and the airstream passes through the at least third body ring airfoil, the at least second body ring airfoil, and the at least first body ring airfoil sequentially.

4. The wind turbine generator of claim 3, wherein the airstream rotates the at least third body ring propeller as it passes through the at least third body ring airfoil.

5. The wind turbine generator of claim 1, further comprising a drive shaft housed in the nacelle.

6. The wind turbine generator of claim 5, wherein the drive shaft is removably coupled to the generator.

7. The wind turbine generator of claim 1, wherein the generator is removably housed in the nacelle.

8. The wind turbine generator of claim 1, further comprising a plurality of ribs disposed on the nacelle.

9. The wind turbine generator of claim 8, wherein the ribs are a heat sink.

10. The wind turbine generator of claim 8, wherein the ribs act to direct the airstream.

11. The wind turbine generator of claim 1, further comprising a diffuser disposed after the first body ring airfoil and before the tail blade.

12. The wind turbine generator of claim 1, wherein the at least first body ring airfoil, the at least second body ring airfoil and the at least third body ring airfoil are removably coupled to the nacelle.

13. The wind turbine generator of claim 1, wherein the at least first body ring propeller, the at least second body ring propeller and the at least third body ring propeller are removably coupled to the at least first body ring airfoil, the at least second body ring airfoil and the at least third body ring airfoil, respectively.

14. The wind turbine generator of claim 1, further comprising an actuated opening on an end of the nacelle.

15. The wind turbine generator of claim 14, wherein the actuated opening at the end of the nacelle is positionable anywhere in a range from fully opened to fully closed.

16. A method of generating electricity with a wind turbine, comprising:
directing an airstream over a nacelle;
directing the airstream through at least a third body ring airfoil to rotate at least a third body ring propeller;
directing the airstream from the at least third body ring airfoil to at least a second body ring airfoil to rotate at least a second body ring propeller;
directing the airstream from the at least second body ring airfoil to at least a first body ring airfoil to rotate at least a first body ring propeller; and
generating electricity with a generator based on the rotation of the first body ring propeller, second body ring propeller and third body ring propeller.

17. The method of generating electricity with a wind turbine according to claim 16, further comprising:
directing the airstream from the at least first body ring airfoil to a tail blade to rotate the tail blade; and
generating electricity with the generator based on the rotation of the tail blade.

18. The method of generating electricity with a wind turbine according to claim 17, further comprising:
directing the airstream from the at least first body ring airfoil to the tail blade through a diffuser positioned between the at least first body ring airfoil and the tail blade.

19. A wind turbine generator, comprising:
means for directing an airstream into a housing;
means for directing the airstream through a plurality of airfoils and a corresponding plurality of propellers; and
means for generating electricity.
